(19) United States
(12) Patent Application Publication
(10) Pub. No.: US 2017/0271901 A1
(43) Pub. Date: Sep. 21, 2017

(54) Battery Booster with Integrated Modular Compressor and Inverter

(71) Applicant: Mathew Inskeep, Highland Beach, FL (US)

(72) Inventor: Mathew Inskeep, Highland Beach, FL (US)

(21) Appl. No.: 15/378,187

(22) Filed: Dec. 14, 2016

Related U.S. Application Data
(60) Provisional application No. 62/248,393, filed on Oct. 30, 2015.

(51) Int. Cl. H02J 7/00; H02M 7/44

(52) U.S. Cl. CPC H02J 7/0052; H02J 7/0065; H02M 7/44; H02J 7/0042; H02J 2007/0062

(57) ABSTRACT

A multi-module base docking station for housing an independent battery module power source that can be coupled mechanically and electrically with other single modules within the same docking station. The multi-module base clocking station has an open cradle design. The single modules are detachable, which allows a user to exchange between single modules available. In one embodiment, the other single modules consist of an air compressor and a power inverter. The docking station is a centralized power supply pack for multiple single modules.

### CROSS-REFERENCE TO RELATED APPLICATIONS

This application claims priority to U.S. Provisional Application Ser. No. 62/248,393, filed on Oct. 30, 2015, the disclosure of which is incorporated herein by reference in its entirety.

### STATEMENT REGARDING FEDERALLY SPONSORED RESEARCH

The invention was not made under government contact nor was funded grant money used to fund the research.

### BACKGROUND OF THE INVENTION

The present invention relates to a consumer electronic multi-module base docking station. Specifically, the invention consists of a multi-module base docking station that will house an independent battery module power source that will be coupled mechanically and electrically with other single modules within the same docking station that may consist of an air compressor and a power inverter. This invention will allow users to exchange between single modules available. The invention will be a centralized power supply pack for multiple tools such as a detachable inverter and air compressor.

### BRIEF SUMMARY OF THE INVENTION

The present invention provides a multi-module base clocking station has an open cradle design, which allows for quick electrical connections between single modules as well as quick stow and release of each individual module. The individual modules can be a power inverter and air compressor.

The main feature of the invention is the battery module power source. This particular module has the capability to provide power to small rechargeable electronic devices via USB receptacle as well as providing power to a vehicle engine. The same module has an integrated power outlet that will supply power to other single modules. Single modules available but not limited are; a vehicle tire inflator, and a power converter source with AG and DC output.

### BRIEF DESCRIPTION OF DRAWINGS

The following is a description of the images related to this invention:

FIG. 1 is a free standing view of the present Invention multi-module base dock station with two single modules,

FIG. 2 is a free standing view of the present invention multi-module base dock, station housing with the power module and an air compressor.

FIG. 3 is an expandable view of the multi-module based dock station light unit with a dual multipurpose power module.

FIG. 4 is an image of the connector type adapters used in parallel with the described invention. The connection type includes a set of alligator clips and a straight connector.

Drawings Number References:

| | |
|---|---|
| 1. Base docking station | 2. Base docking station Slot 1 |
| 3. Base docking station Slot 2 | 4. Self-contained power module |
| 5. Self-contained power | 6. Dual barrel connector |
| module control panel | |
| 7. Dual barrel conductor wire | 8. Air compressor unit module |
| 9. Multipurpose power source module | 10. Straight accessory outlet |
| connector | |
| 11. Battery clips clamps | 12. USB receptacle |

13. Area light

### DETAILED DESCRIPTION OF THE INVENTION

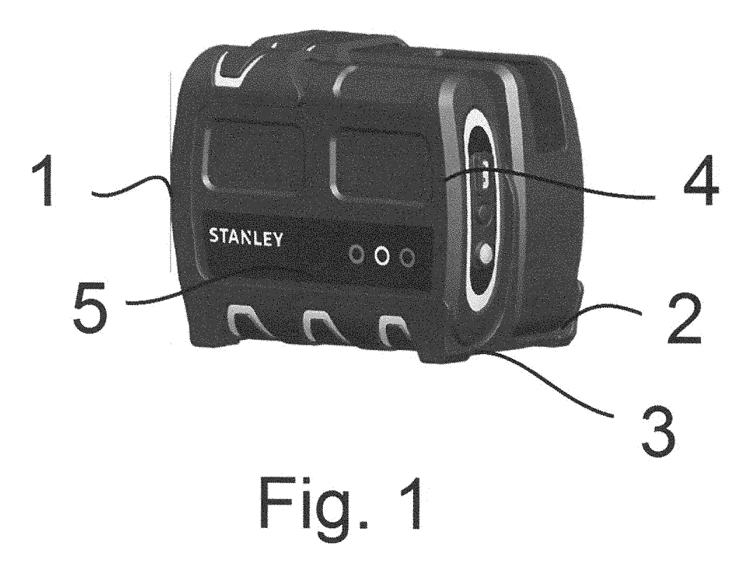

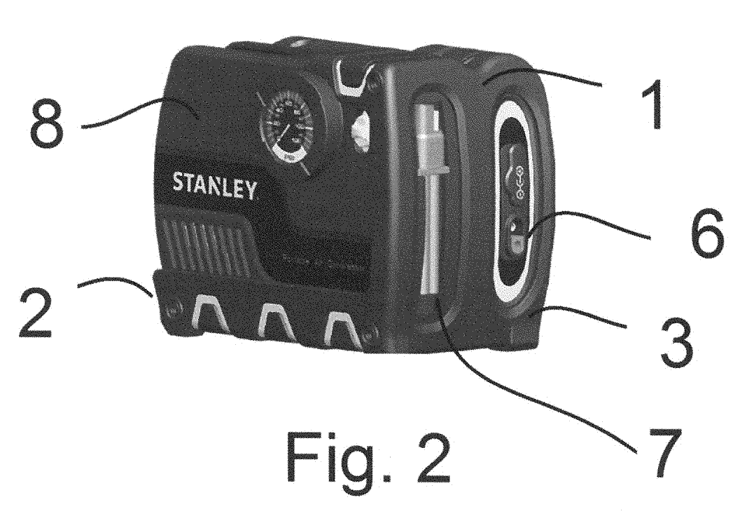

FIG. 1 shows a two-dimension view of the present invention. The multi-module base docking station 1 is of a slim and compact design that accommodates and houses single preset modules. Additional features include a base docking station with slot 1 and slot 2 call out image numbers 2 and 3. There is a preset destination for each individual single module in order to properly align the electrical connection. FIG. 1 also depicts a self-contained power module 4 with its control panel 5. This module has several consumer useful features. One feature provides a USB receptacle 12 to recharge or power small electronic devices. A second feature provides an area LED light 13 primarily for nighttime use. Finally, a high output power pert FIG. 2 call out 6 to provide a quick charge to a motor vehicles battery engine and also serves as an output to any other module, as explained below. The mechanical connection of any one single module is achieved by sliding into the base of the docking station.

FIG. 2 shows the electrical connection, as well as a secondary module within the same base docking station as previously shown on FIG. 1. The electrical coupling of each modulo is achieved using the dual barrel conductor wire 7 and connecting it into the Dual barrel connector 6 located in the Self-contained power module 4, The air compressor unit module will be using the energy from the self-contained power module in order to operate. Additionally, this air compressor unit module 8 can also be used outside the base docking station and connect with a supply cord for a straight accessory outlet connector 10 or Battery clips clamps 11 as shown in FIG. 4.

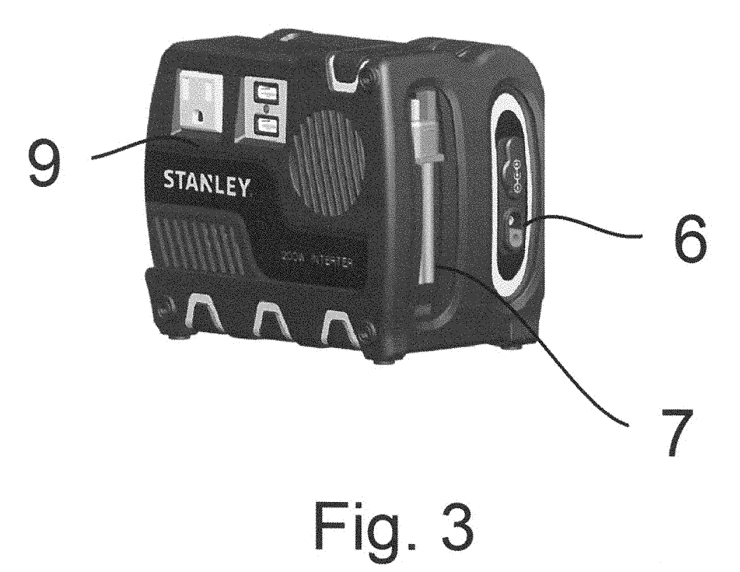

Further expansion of the invention is shown on FIG. 3. This is an additional preset module for multipurpose power source. This particular module has the capability to output household type electrical current in conjunction with low power direct current.

1. A multi-module base docking station.

2. A multi-module base docking station with multiple slots.

3. A multi-module base docking station housing an independent battery module power source.

4. A multi-module base docking station housing an independent battery module power source with electrical connection to preset modules.

5. A multi-base docking station with integrated compressor and inverter.
